(19) United States
(12) Patent Application Publication
(10) Pub. No.: US 2017/0198109 A1
(43) Pub. Date: Jul. 13, 2017

(54) PRODUCTION OF POLY ALPHA-1,3-GLUCAN FORMATE FILMS

(71) Applicant: E I DU PONT DE NEMOURS AND COMPANY, Wilmington, DE (US)

(72) Inventors: Vindhya Mishra, Wilmington, DE (US); Colin Marshall, Wigton (GB); Jamie Moffat, Aspatria (GB)

(21) Appl. No.: 15/320,864

(22) PCT Filed: Jun. 25, 2015
(86) PCT No.: PCT/US2015/037628

§ 371 Date: Dec. 21, 2016

Related U.S. Application Data
(60) Provisional application No. 62/017,475, filed on Jun. 26, 2014.

(51) Int. Cl. C08J 5/18; G09F 3/02; B29C 71/00; B29C 47/88; C08B 37/00; B29C 47/00

(52) U.S. Cl. CPC C08J 5/18; C08B 37/0009; B29C 47/0004; B29C 47/0021; B29C 71/0009; B29C 47/8895; G09F 3/02; C08J 2305/00; B29K 2001/08

(57) ABSTRACT

A process for making poly alpha-1,3-glucan formate films by extrusion is disclosed. These films are translucent or transparent and can be used in packaging applications.

### CROSS-REFERENCE TO RELATED APPLICATION

This disclosure claims the benefit of priority of U.S. Provisional Application No. 62/017,475, filed on Jun. 26, 2014, the entirety of which is herein incorporated by reference.

### FIELD OF THE INVENTION

This invention relates to poly alpha-1,3-glucan formate films and methods of their preparation.

### BACKGROUND

Glucose-based polysaccharides and their derivatives can be of potential industrial application.

Cellulose is a typical example of such a polysaccharide and is comprised of beta-1,4-D-glycosidic linkages of hexopyranose units. Cellulose and cellulose derivatives such as cellulose acetates are used for several commercial applications such as in the manufacture of films for LCD polarizers, labels, packaging etc. Cellulose and derivatives thereof for industrial applications are typically derived from wood pulp, but may also be derived from pulps of cotton, flax hemp or bamboo. For cellulose film production the most commonly used process for dissolution of cellulose is the ‘viscose process’. As those skilled in the art will be aware, the viscose process as generally practiced includes the steps of dissolving or slurrying a cellulose pulp in sodium hydroxide, steeping it in a sodium hydroxide solution, optionally mercerising the cellulose slurry to remove a portion of the sodium hydroxide solution, xanthating the cellulose with carbon disulfide, and redissolving it in an aqueous sodium hydroxide solution to form viscose i.e. a solution of cellulose xanthate.

The viscose is typically filtered and refiltered in order to maximise the purity of the material to improve product quality. It is then formed into a desired shape, for example a fiber or film, using techniques known to those skilled in the art, for example by extruding it through a slit or rollers to form a sheet of film, or by extruding it through a spinnerette to form a fibrous material. The shaped viscose is then contacted with an acidic casting solution to regenerate the cellulose from the viscose.

However, the viscose process has numerous disadvantages associated therewith, for example it involves the use of toxic chemicals, in particular carbon disulfide, and has significant environmental costs. Compared to cellulose films, cellulose derivative films such as cellulose acetates offer advantages of increased moisture stability compared to cellulose films. However, synthesis of cellulose derivatives is an expensive and difficult procedure. The cellulose derivative is first synthesized, recovered and dried. In a second step, the derivative is dissolved into solvents and formed into further products like films and fibers.

Another example of a glucose-based polysaccharide is a glucan polymer containing alpha-1,3-glycoside linkages. Glucan polymers have been shown to possess significant advantages, for example U.S. Pat. No. 7,000,000 describes a process for the preparation of a polysaccharide fiber comprising a polymer with hexose units, wherein at least 50% of the hexose units within the polymer are linked via alpha-1,3-glycoside linkages, and a number average degree of polymerization of at least 100. A glucosyltransferase enzyme from Streptococcus salivarius (gtfJ) is used to produce the polymer.

It would be desirable to manufacture films composed of a polysaccharide glucan polymer derivative with increased moisture stability compared to cellulose film. It would also be desirable to manufacture such films without using toxic chemicals, in particular carbon disulfide. It would further be desirable to produce glucan polymer derivative films via a simplified process compared to the production of cellulose derivative films.

### SUMMARY

In a first embodiment, the disclosure concerns a process for making a poly alpha-1,3-glucan formate film comprising: (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan formate film.

In a second embodiment, the disclosure concerns the solvent composition comprises: (a) at least about 80% formic acid and at most about 20% water; (b) at least about 90% formic acid and at most about 10% water; or (c) at least about 95% formic acid and at most 5% water.

In a third embodiment, the disclosure concerns the process according to claim 1, wherein the solvent composition further comprises a solubility additive, a plasticizer additive or a mixture thereof.

In a fourth embodiment, the disclosure concerns the poly alpha-1,3-glucan is dissolved in the solvent composition at a concentration of: (a) from about 2 wt % to about 20 wt %; (b) from about 3 wt % to about 15 wt %; or (c) from about 5 wt % to about 10 wt %.

In a fifth embodiment, the disclosure concerns the coagulation bath comprises a water bath.

In a sixth embodiment, the disclosure concerns the film-shaped wet gel has a breaking stress of at least about 1.5 MPa, at least about 2.0 MPa or at least about 2.5 MPa.

In a seventh embodiment, the disclosure concerns a poly alpha-1,3-glucan formate film made according to a process comprising: (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan formate film.

In an eighth embodiment, the disclosure concerns a film comprising poly alpha-1,3-glucan formate.

In a ninth embodiment, the disclosure concerns the film has at least one of: (a) a haze of less than about 10%, less than about 5% or less than about 3%; or (b) a breaking stress of from about 10 to about 100 MPa.

In a tenth embodiment, the disclosure concerns the poly alpha-1,3-glucan formate has a formate degree of substitution (DoS) of from about at least 0.1 to 3.

In an eleventh embodiment, the disclosure concerns a label, packaging article or security document comprising the film made according to a process comprising: (1) (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan formate film, or (2) (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; (e) removing the water from the film-shaped wet gel to form a poly alpha-1,3-glucan formate film; and (f) removing the formate in the poly alpha-1,3-glucan formate film to form the poly alpha-1,3-glucan film.

In a twelfth embodiment, the disclosure concerns an article labelled with or packaged by the label or packaging article.

In a thirteenth embodiment, the disclosure concerns a process for making a poly alpha-1,3-glucan film comprising: (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; (e) removing the water from the film-shaped wet gel to form a poly alpha-1,3-glucan formate film; and (f) removing the formate in the poly alpha-1,3-glucan formate film to form the poly alpha-1,3-glucan film.

In a fourteenth embodiment, the disclosure concerns the formate in the poly alpha-1,3-glucan formate film is removed by washing the poly alpha-1,3-glucan formate film with sulfuric acid, dilute caustic, basic buffer or by boiling in acidic or basic water.

### DETAILED DESCRIPTION

The term “film” used herein refers to a thin, visually continuous material.

The term “packaging film” used herein refers to a thin, visually continuous material partially or completely surrounding an object.

The term “film shaped wet gel” or “wet gel” used herein refers to the thin, visually continuous, coagulated form of the film-forming solution

The term “plasticizing” used herein refers the well-known effect of using an additive to achieve softening which involves at least one of (a) lowering of rigidity at room temperature; (b) lowering of temperature, at which substantial deformations can be effected with not too large forces or (c) increase of the elongation to break at room temperature.

The term “solvent composition” used herein refers to the mixture of compounds that are needed to dissolve a polymer.

The terms “poly alpha-1,3-glucan”, “alpha-1,3-glucan polymer” and “glucan polymer” are used interchangeably herein. Poly alpha-1,3-glucan is a polymer where the structure of poly alpha-1,3-glucan can be illustrated as follows (where n is 8 or more):

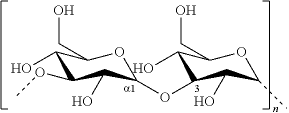

The term “glucan formate” and “poly alpha-1,3-glucan formate” refers to a derivatized form of poly alpha-1,3-glucan where at least one monomer in poly alpha-1,3-glucan has one or more hydroxyl groups of poly alpha-1,3-glucan that have reacted to form a formate group (—CHOO), the remaining hydroxyl groups may remain unreacted. The structure of poly alpha-1,3-glucan formate where all the hydroxyl groups have reacted to form formate groups can be illustrated as follows (where n is 8 or more):

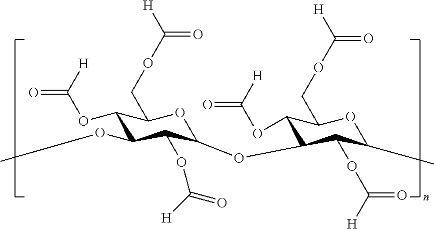

This invention relates to poly alpha-1,3-glucan formate films and poly alpha-1,3-glucan films and the methods of their production from a polysaccharide poly alpha-1,3-glucan.

According to a first aspect of the present invention there is provided a process for making a poly alpha-1,3-glucan formate film, comprising: (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan formate film.

Poly alpha-1,3-glucan may be prepared using chemical methods. Alternatively, poly alpha-1,3-glucan may be prepared by extracting it from various organisms, such as fungi, that produce poly alpha-1,3-glucan. Another alternative may be to enzymatically produce poly alpha-1,3-glucan from renewable resources, such as sucrose, using one or more glucosyl-transferase (e.g., gtfJ) enzyme catalysts found in microorganisms as described in the co-pending, commonly owned U.S. Patent Application Publication No. 2013/0244288 which is herein incorporated by reference in its entirety.

The poly alpha-1,3-glucan may have a degree of polymerisation (DPw) of at least about 400. Preferably, the poly alpha-1,3-glucan has a DPw of from about 400 to about 1400, or from about 600 to about 1300.

The process of the present invention involves dissolving poly alpha-1,3-glucan in an aqueous formic acid solvent composition to provide a solution of poly alpha-1,3-glucan formate. The dissolution and conversion of the poly alpha-1,3-glucan into poly alpha-1,3-glucan formate occurs simultaneously, which eliminates the need for a two step process of synthesis and recovery of the derivative, followed by dissolution of the derivative in a solvent system. The poly alpha-1,3-glucan may be mixed with the solvent composition by the application of shear to obtain clear solutions by derivatization of the poly alpha-1,3-glucan to form poly alpha-1,3-glucan formate.

The poly alpha-1,3-glucan is dissolved in the solvent composition at a concentration of from about 2 wt % to about 20 wt %, more preferably from about 3 wt % to about 15 wt % and most preferably from about 5 wt % to about 10 wt %. The concentration of the poly alpha-1,3-glucan used may depend on the DPw of the poly alpha-1,3-glucan used, in particular a higher concentration of poly alpha-1,3-glucan may be used when the DPw of the poly alpha-1,3-glucan used is lower and vice versa.

For example, for a poly alpha-1,3-glucan with DPw of 1250, the poly alpha-1,3-glucan concentration is preferably at least about 5 wt %. For a poly alpha-1,3-glucan with DPw of 800, the poly alpha-1,3-glucan concentration is preferably at least about 7 wt %. For a poly alpha-1,3-glucan with DPw of 400, the poly alpha-1,3-glucan concentration is preferably at least about 11 wt %.

For high molecular weight glucan polymer solutions with a glucan polymer concentration of about 10 wt % for example, the mixture may have a high initial viscosity. Where this is the case, the mixture may be allowed to age, which may result in a reduction of the viscosity over time. Without wishing to be bound by any such theory, it is believed that the decrease in viscosity over time is likely due to increased substitution of the glucan backbone. More specifically, it is believed that as a greater percentage of the backbone is derivatized i.e. as the number of formate groups increases, the solubility of the glucan polymer increases.

The glucan monomer has 3 functional groups that can be derivatized with formate. This gives a maximum degree of substitution (DoS) of 3. It should be noted that the process of the invention may produce a poly alpha-1,3-glucan formate film with a DoS of formate of 3 or less depending on the reaction conditions. The DoS of formate comprises preferably from at least about 0.1 to at most 3, more preferably from at least about 1 to at most 3, and most preferably from at least about 1 to at most 2.

The solvent composition may comprise at least about 80% formic acid and at most about 20% water, preferably at least about 90% formic acid and at most about 10% water, and most preferably at least about 95% formic acid and at most 5% water. The aqueous acid concentration is preferably around 90% formic acid, most preferably around 95% formic acid. A polymer solution with a solvent composition comprising 90% formic acid and 10% water for example, may be achieved using one of three different methods. The method used may impact the final solution and film properties.

In the first method, the glucan polymer is slurried in water, and formic acid is added to achieve a solvent mixture of 90% formic acid and 10% water.

In the second method, a mixture composed of 90% formic acid and 10% water is prepared and the glucan polymer is added to this mixture.

In the third method, the glucan polymer solution is made by using an initial solvent composition of 99.9% formic acid, mixing the polymer until dissolution occurs and then adding water to achieve a final solvent composition of 90% formic acid and 10% water. It will be appreciated that any of the three methods may be used with different amounts of formic acid and water.

Without wishing to be bound by any such theory, it is believed that the differences in the solution and film properties are likely due to difference in initial dispersion of the glucan polymer phase and differences in the degree and distribution of substituted groups on the glucan polymer backbone.

The solvent composition may further comprise one or more additives, for example a solubility additive, a plasticizer additive or a mixture thereof. The one or more additives may comprise alkyoxylated alcohols e.g. ethoxylated alcohols, propylene glycols, polyethylene glycols, polyvinyl alcohols, polyacrylates, urea and/or glycerol.

After creating a solution by one of these means, the solution of poly alpha-1,3-glucan formate may be extruded through a slot die into a coagulation bath, followed by a series of wash steps. The coagulation bath may comprise a water bath. The film may be plasticized by treatment in a plasticizer bath. The plasticizer may comprise alkyoxylated alcohols e.g. ethoxylated alcohols, propylene glycols, polyethylene glycols, polyvinyl alcohols, polyacrylates, urea and/or glycerol.

The film-shaped wet gel may have a breaking stress of at least about 1.5 MPa, preferably at least about 2.0 MPa and most preferably at least about 2.5 MPa.

Finally, the residual solvent/water is removed to form a poly alpha-1,3-glucan formate film. Generally, the solvent composition may be removed by evaporation at room temperature or at an elevated temperature. It should be noted that depending on the solvent composition removal technique, some residual solvent composition or its constituents may be present in small amounts.

The film thus obtained may be transparent. The film may have a glossy or a matte appearance. The film may have at least one of: (a) a haze of less than about 10%, or less than about 5%, or less than about 3%; or (b) a breaking stress of from about 10 to about 100 MPa. The film produced using the process of the present invention is flexible and exhibits good dead fold characteristics. Additionally, the film may be twisted and dyed. The film may be used as packaging film.

The resulting alpha-1,3-glucan formate film may have a thickness of from about 10 μm to about 300 μm, from about 10 μm to about 200 μm, or from about 10 μm to about 100 μm.

Advantageously, the process of the present invention does not require the use of toxic chemicals, in particular carbon disulfide. In addition, fewer process steps are required to form the glucan film of the present invention compared to the conventional process for forming cellulose film.

According to a second aspect of the present invention there is provided a film comprising poly alpha-1,3-glucan formate formed using the process of the first aspect of the present invention.

According to a third aspect of the present invention there is provided a process for making a poly alpha-1,3-glucan film comprising: (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; (e) removing the water from the film-shaped wet gel to form a poly alpha-1,3-glucan formate film; and (f) removing the formate in the poly alpha-1,3-glucan formate film to form the poly alpha-1,3-glucan film.

The formate in the poly alpha-1,3-glucan formate film may be removed by washing the poly alpha-1,3-glucan formate film with dilute sulfuric acid, dilute caustic or boiling in acidic or basic water.

The degree of substitution of the glucan formate groups may be decreased by de-esterification in dilute sulfuric acid, dilute caustic, or boiling in mild acidic or basic conditions, where the extent of the treatment time and the concentration of the bath controls the reduction in the DoS.

According to a fourth aspect of the present invention there is provided a poly alpha-1,3-glucan film formed using the process of the third aspect of the present invention.

For the avoidance of doubt, all features relating to the first aspect of the invention also relate to the second, third and fourth aspects of the invention where appropriate, and vice versa.

The present disclosure is directed toward a process for making a poly alpha-1,3-glucan formate film comprising: (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan formate film. The solvent composition may comprise: (a) at least about 80% formic acid and at most about 20% water; (b) at least about 90% formic acid and at most about 10% water; or (c) at least about 95% formic acid and at most 5% water. The solvent composition can further comprise a solubility additive, a plasticizer additive or a mixture thereof. The poly alpha-1,3-glucan can be dissolved in the solvent composition at a concentration of: (a) from about 2 wt % to about 20 wt %; (b) from about 3 wt % to about 15 wt %; or (c) from about 5 wt % to about 10 wt %. The coagulation bath may comprise a water bath. The film-shaped wet gel can have a breaking stress of at least about 1.5 MPa, at least about 2.0 MPa or at least about 2.5 MPa.

The present disclosure is further directed toward a poly alpha-1,3-glucan formate film made according to a process comprising: (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan formate film.

The present disclosure is still further directed toward a film comprising poly alpha-1,3-glucan formate. The film can have at least one of: (a) a haze of less than about 10%, less than about 5% or less than about 3%; or (b) a breaking stress of from about 10 to about 100 MPa. The poly alpha-1,3-glucan formate can have a formate degree of substitution (DoS) of from about at least 0.1 to 3.

The present disclosure is still further directed toward a label, packaging article or security document comprising the film made according to a process comprising: (1) (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan formate film, or (2) (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; (e) removing the water from the film-shaped wet gel to form a poly alpha-1,3-glucan formate film; and (f) removing the formate in the poly alpha-1,3-glucan formate film to form the poly alpha-1,3-glucan film. An article labelled with or packaged by the label or packaging article.

The present disclosure is still further directed toward a process for making a poly alpha-1,3-glucan film comprising: (a) dissolving poly alpha-1,3-glucan in an aqueous formic acid solvent composition to provide a solution of poly alpha-1,3-glucan formate; (b) extruding the solution of poly alpha-1,3-glucan formate into a coagulation bath to make a film-shaped wet gel; (c) washing the film-shaped wet gel with water; (d) optionally, plasticizing the film-shaped wet gel with a plasticizer additive; (e) removing the water from the film-shaped wet gel to form a poly alpha-1,3-glucan formate film; and (f) removing the formate in the poly alpha-1,3-glucan formate film to form the poly alpha-1,3-glucan film. The formate in the poly alpha-1,3-glucan formate film can be removed by washing the poly alpha-1,3-glucan formate film with sulfuric acid, dilute caustic, basic buffer or by boiling in acidic or basic water.

### EXAMPLES

The present disclosure is further exemplified in the following Examples. It should be understood that these Examples, while indicating certain preferred aspects herein, are given by way of illustration only. From the above discussion and these Examples, one skilled in the art can ascertain the essential characteristics of the disclosed embodiments, and without departing from the spirit and scope thereof, can make various changes and modifications to adapt the disclosed embodiments to various uses and conditions.

The Following Abbreviations were Used in the Examples

“DI water” is deionized water; “MPa” is megapascal; “ml” is milliliters; “l” is liters; “m” is meters; “min” is minutes; “sq” is square; “wt %” is weight percent; “PDI” is the polydispersity index; “DPw” is weight average degree of polymerization. “NMR” is nuclear magnetic resonance; “DoS” refers to degree of substitution.

### General Methods

Degree of Polymerization (DPw) and Polydispersity Index (PDI) were determined by Multidetector Size Exclusion Chromatography (SEC) method. The molecular weight of a poly alpha-1,3-glucan can be measured as number-average molecular weight (Mₙ) or as weight-average molecular weight (M_{w}). The degree of polymerization can then be expressed as DP_{w} (weight average degree of polymerization) which is obtained by diving M_{w} of the polymer by the weight of the monomer unit, or DPₙ (number average degree of polymerization) which is obtained by dividing Mₙ of the polymer by the weight of the monomer unit. The chromatographic system used was Alliance™ 2695 separation module from Waters Corporation (Milford, Mass.) coupled with three on-line detectors: differential refractometer (DR) 2410 from Waters, multiangle light scattering photometer Heleos™ 8+ from Wyatt Technologies (Santa Barbara, Calif.) and differential capillary viscometer ViscoStar™ from Wyatt. The software packages used for data reduction were Empower™ version 3 from Waters (column calibration with broad glucan standard, DR detector only) and Astra version 6 from Wyatt (triple detection method without column calibration). Four SEC styrene-divinyl benzene columns from Shodex (Japan) were used—two linear KD-806M, KD-802 and KD-801 to improve resolution at low molecular weight region of a polymer distribution. The mobile phase was N,N′-Dimethyl Acetamide (DMAc) from J. T Baker, Phillipsburg, N.J. with 0.11% LiCl (Aldrich, Milwaukee, Wis.). The chromatographic conditions were as follows: temperature at column and detector compartments: 50° C., temperature at sample and injector compartments: 40° C., flow rate: 0.5 ml/min, injection volume: 100 μl. The sample preparation targeted 0.5 mg/mL sample concentration in DMAc with 5% LiCl, shaking overnight at 100° C. After dissolution, polymer solution can be stored at room temperature. This method was used to measure molecular characteristics of glucan polymers (average molecular weights and degree of polymerization, molecular weight distribution and PDI).

Degree of Substitution (DoS) was determined from ¹H nuclear magnetic resonance spectroscopy (NMR). Approximately 20 mg of the polymer sample was weighed into a vial on an analytical balance. The vial was removed from the balance and 0.7 mL of deuterated trifluoroacetic acid was added to the vial. A magnetic stir bar was added to the vial and the mixture was stirred until the solid sample dissolves. Deuterated benzene (C6D6), 0.3 mL, was then added to the vial in order to provide a better NMR lock signal than the TFA,d would provide. A portion, 0.8 mL, of the solution was transferred, using a glass pipet, into a 5 mm NMR tube. A quantitative ¹H NMR spectrum was acquired using an Agilent VnmrS 400 MHz NMR spectrometer equipped with a 5 mm Auto switchable Quad probe. The spectrum was acquired at a spectral frequency of 399.945 MHz, using a spectral window of 6410.3 Hz, an acquisition time of 1.278 seconds, an inter-pulse delay of 10 seconds and 124 pulses. The time domain data was transformed using exponential multiplication of 0.78 Hz. Two regions of the resulting spectrum were integrated; from 3.1 ppm to 6.0 ppm, that gives the integral for the 7 protons on the poly alpha-1,3-glucan ring, and from 7.7 ppm to 8.4 ppm that gives the integral for the protons on the formate group. The degree of substitution was calculated by dividing the formate protons integral area by one seventh of the poly alpha-1,3-glucan ring protons integral area.

Film Clarity or haze value was determined using an Agilent (Varian) Cary 5000 uv/vis/nir spectrophotometer equipped with a DRA-2500 diffuse reflectance accessory in transmission mode. The DRA-2500 is a 150 mm integrating sphere with a Spectralon® coating. Total and diffuse transmission for the instrument and the samples are collected over the wavelength range of 830 nm to 360 nm. The calculations are made in accordance with ASTM D1003 using a 2 degree observer angle and illuminant C (represents average daylight, color temperature 6700K). Haze value was reported in percentage (%).

Thickness of the film was determined using a Mitutoyo micrometer, No. 293-831 and reported in mm or micron.

Tensile Properties were measured on an Instron 5500R Model 1122, using 1″ grips, and a 1″ gauge length, in accordance with ASTM D882-09. Breaking stress was reported in MPa and maximum strain was reported in %.

Oxygen and Water Vapor Permeability was determined using a MOCON Permatron-W 101K instrument according to ASTM F1927 and ASTM F1249 respectively. Oxygen permeability was reported in cm³/m²/day. Water vapor permeability was reported in gm-m/m²/day.

### Preparation of Poly Alpha-1,3-Glucan

Poly alpha-1,3-glucan, using a gtfJ enzyme preparation, was prepared as described in the co-pending, commonly owned U.S. Patent Application Publication Number 2013-0244288 which was published on Sep. 19, 2013, the disclosure of which is incorporated herein by reference.

### Materials

Formic acid, NaOH and buffer solutions were obtained from Sigma Aldrich (St. Louis, Mo.). Sulphuric acid was obtained from EMD Chemicals (Billerica, Mass.).

### Example 1

### Process for Making a Poly Alpha-1,3-Glucan Formate Film

A solvent mixture of 94.4% formic acid was made by mixing 99.4% formic acid with DI water. Twenty g of 100% dry glucan, DPw 1250, was weighed out into a 500 mL round bottom flask. 180 g of the formic acid solution was added to the round bottom and stirred using an IKA overhead stirrer and glass stirring rod with a half moon paddle. The final solution concentration was 10% glucan solids, ˜85% formic acid, 5% water. This solution concentration is termed as 10% glucan in 94.4% formic acid. This was allowed to mix for 21 hours until a clear, uniform solution was achieved. The solution was centrifuged to remove air bubbles. The solution was spread onto a glass plate by pouring a controlled amount of solution onto a glass plate, and then drawn down using a Meyer rod. The solution and the plate with was immediately immersed in a water bath until the film-shaped wet gel was formed. In most instances, the film-shaped wet gel removed itself from the glass. It should be noted that the solution of poly alpha-1,3-glucan formate can be extruded directly into the coagulation bath. The glass plate was used in this example due to equipment limitations. The film-shaped wet gel was then placed in a new water bath to wash off residual formic acid. This washing process was repeated until the pH of the bath remained neutral after the film was soaked for 10 minutes. The film-shaped wet gel was removed from the bath. This process produced a smooth, flat film-shaped wet gel with a thickness of 114.3 micron. The film-shaped wet gel was divided into two halves and tensile strength was measured on one-half. The tensile strength was found to be max strain of 197.4% and a breaking stress of 5.4 MPa. The film-shaped wet gel appeared colorless and transparent to the human eye while wet. The other half of remaining wet gel was allowed to air dry overnight and produced a clear, flexible film with a haze value of <2%.

Thus, a poly alpha-1,3-glucan formate film was made according to the present disclosure.

### Examples 2-10

### Process for Making Poly Alpha-1,3-Glucan Formate Films Prepared from a Range of Poly Alpha-1,3-Glucan Formate DPw Values

Examples 2-10 were prepared in a similar manner to Example 1 except different glucan polymers with different DPw values were used and film-shaped wet gels with different thicknesses were made. Tensile strength was measured and summarized in the Table. All of the dried films were clear.

TABLE
Alpha-1,3-Glucan Formate Film-Shaped Wet Gel Physical Properties

| | | | Breaking | Maximum |
|---|---|---|---|---|
| | Glucan | Thickness | Stress | Strain to |
| Example | DPw | (micron) | (MPa) | Break (%) |
| 1 | 1250 | 114.3 | 5.4 | 197.4 |
| 2 | 1250 | 155.0 | 6.6 | 236.1 |
| 3 | 1000 | 124.5 | 2.7 | 119.7 |
| 4 | 1000 | 221.0 | 2.2 | 119.3 |
| 5 | 800 | 116.8 | 3.2 | 116.8 |
| 6 | 800 | 223.5 | 3.3 | 139.7 |
| 7 | 800 | 81.3 | 2.9 | 98.0 |
| 8 | 800 | 228.6 | 3.3 | 149.8 |
| 9 | 650 | 101.6 | 3.9 | 199.2 |
| 10 | 650 | 221.0 | 2.6 | 185.7 |

Thus, Examples 1-10 show that glucan formate films of different thicknesses can be made from polymer of different DPw values.

### Example 11

### Process for Making a Poly Alpha-1,3-Glucan Formate Film

Example 11 was prepared in the following manner: a solvent mixture of 94.4% formic acid was made by mixing 99.4% formic acid with water in an IBC mixer. Glucan polymer of DPw 1250 was added via a hopper into mixer housing under high shear and mixed for 10 minutes. The overall mixture composition was 5 wt % Glucan in 95% formic acid solvent and the overall solution weight was 300 kg. The mixture was continued to mix in the IBC mixer till the solution viscosity increased to form a thick gel. The mixture was then aged overnight. The solution viscosity the next day was measured to be 5 Pas at 20° C. The solution was then fed into a slot die at a flow rate of 22 l/min and extruded directly into a water coagulation bath of volume 100 l. The solution coagulated in the water bath to form a wet gel. The film-shaped wet gel appeared colorless and transparent to the human eye while wet. The wet gel then passed through additional water baths of volume 50 l and a plasticizer bath composed of 50 l of 5 wt % monopropylene glycol in water. A sample of the wet gel was collected from the final water wash bath prior to plasticization and the wet gel strength and degree of substitution measured. The wet gel thickness averaged over 5 samples was 0.189 mm and the average wet gel strength was 1.96 MPa. The degree of substitution of the sample was measured to be 1.27. Post plasticization, the wet gel was dried by passing over 8 drying cylinders. The first two drying cylinders were set to 96° C. while drying cylinder numbers 3-8 were set to 85° C. The line speed was maintained at 5 m/min during this continuous operation. The film was edge-trimmed and collected on a wind up roll. Thus produced dry film had a thickness of 14 micron, softener content of 10.9%, moisture level of about 3%, an oxygen transmission rate of 24.7 cm³/m²/day at 23° C./50% relative humidity and a water vapor transmission rate of 0.008128 gm-m/m²/day at 23° C., 90% relative humidity. Thus produced dry film had a breaking stress of 60 MPa in the machine direction (MD) and 50 MPa in the transverse direction (TD).

Thus, this Example demonstrates that an alpha-1,3-glucan formate film can be made by a commercially relevant continuous extrusion process.

### Example 12

### Process for Making a Poly Alpha-1,3-Glucan Formate Film with Different Process Conditions

Example 12 was prepared using similar process as example 11 but using a different dope composition and different process conditions. The overall dope mixture composition was 7 wt % Glucan DPw 800 in 95% formic acid solvent. The dope flow rate was 29 l/min, while the line speed was 4.5 m/min The produced dry film had a thickness of 16 micron, an oxygen transmission rate of 4.1 cm³/m²/day at 23° C./50% relative humidity and a water vapor transmission rate of 0.00988 gm-m/m²/day at 23° C., 90% relative humidity.

Thus, this Example demonstrates that an alpha-1,3-glucan formate film can be made under different process conditions.

### Example 13

### Process for Making a Poly Alpha-1,3-Glucan Formate Film with Reduced DoS

Example 13 was prepared in the following manner. Poly alpha-1,3-glucan with a DPw of 800 was mixed with a 95% solution of formic acid and DI water. The final solution composition was 10 wt % polymer, 85.5% formic acid and 4.5% DI water. The solution was stirred and the viscosity increased significantly forming a thick gel-like consistency. The stirring was allowed to continue for 21 hours during which the solution viscosity decreased and the solution became pourable. A film was cast on glass, coagulated in water, washed in a 0.1% NaOH bath for 1 minute, then rinsed in water until neutral. The resulting film was clear. The DoS of formate in the film measured using ¹H NMR and was found to be 1.1.

Thus, the DoS of the resulting film can be reduced if desired by treatment with a basic solution.

### Example 14

### Process for Making a Poly Alpha-1,3-Glucan Formate Film with Reduced DoS

The solution for Comparative Example A was prepared in the same manner as Example 13. A film was cast on glass, coagulated in water until it remained neutral and air dried. The resulting film was clear. The DoS of formate in the film measured using ¹H NMR and was found to be 1.47.

Thus, the DoS of the resulting film can be reduced if desired by treatment with a basic solution.

### Example 15

### Process for Making a Poly Alpha-1,3-Glucan Film from a Poly Alpha-1,3-Glucan Formate Film

A glucan formate film with a DoS of formate of 1.1 was placed in a buffer solution of pH 10 for 18 hours. The film was rinsed with water and allowed to air dry. The DoS of formate in the film measured using ¹H NMR. No formate group was detected in NMR measurement.

Thus, this demonstrates that formate content of the film may be removed by treatment with a basic buffer.

What is claimed is:

1. A process for making a poly alpha-1,3-glucan formate film comprising:
(a) dissolving poly alpha-1,3-glucan in an aqueous formic acid solvent composition to provide a solution of poly alpha-1,3-glucan formate;
(b) extruding the solution of poly alpha-1,3-glucan formate into a coagulation bath to make a film-shaped wet gel;
(c) washing the film-shaped wet gel with water;
(d) optionally, plasticizing the film-shaped wet gel with a plasticizer additive; and
(e) removing the water from the film-shaped wet gel to form a poly alpha-1,3-glucan formate film.

2. The process according to claim 1, wherein the solvent composition comprises:
(a) at least about 80% formic acid and at most about 20% water;
(b) at least about 90% formic acid and at most about 10% water; or
(c) at least about 95% formic acid and at most 5% water.

3. The process according to claim 1, wherein the solvent composition further comprises a solubility additive, a plasticizer additive or a mixture thereof.

4. The process according to claim 1, wherein the poly alpha-1,3-glucan is dissolved in the solvent composition at a concentration of:
(a) from about 2 wt % to about 20 wt %;
(b) from about 3 wt % to about 15 wt %; or
(c) from about 5 wt % to about 10 wt %.

5. The process according to claim 1, wherein the coagulation bath comprises a water bath.

6. The process according to claim 1, wherein the film-shaped wet gel has a breaking stress of at least about 1.5 MPa, at least about 2.0 MPa or at least about 2.5 MPa.

7. A poly alpha-1,3-glucan formate film made according to claim 1.

8. A film comprising poly alpha-1,3-glucan formate.

9. The film according to claim 8, wherein the film has at least one of:
(a) a haze of less than about 10%, less than about 5% or less than about 3%; or
(b) a breaking stress of from about 10 to about 100 MPa.

10. The film according to claim 8, wherein the poly alpha-1,3-glucan formate has a formate degree of substitution (DoS) of from about at least 0.1 to 3.

11. A label, packaging article or security document comprising the film of claim 8.

12. An article labelled with or packaged by the label or packaging article of claim 11.

13. A process for making a poly alpha-1,3-glucan film comprising:
(a) dissolving poly alpha-1,3-glucan in an aqueous formic acid solvent composition to provide a solution of poly alpha-1,3-glucan formate;
(b) extruding the solution of poly alpha-1,3-glucan formate into a coagulation bath to make a film-shaped wet gel;
(c) washing the film-shaped wet gel with water;
(d) optionally, plasticizing the film-shaped wet gel with a plasticizer additive;
(e) removing the water from the film-shaped wet gel to form a poly alpha-1,3-glucan formate film; and
(f) removing the formate in the poly alpha-1,3-glucan formate film to form the poly alpha-1,3-glucan film.

14. The process according to claim 13, wherein the formate in the poly alpha-1,3-glucan formate film is removed by washing the poly alpha-1,3-glucan formate film with sulfuric acid, dilute caustic, basic buffer or by boiling in acidic or basic water.
